(19) United States
(12) Patent Application Publication
(10) Pub. No.: US 2008/0036872 A1
(43) Pub. Date: Feb. 14, 2008

(54) IMAGE PROCESSING SYSTEM, DISPLAY DEVICE, PROGRAM, AND INFORMATION RECORDING MEDIUM

(75) Inventor: Tatsuhiko NOBORI, Matsumoto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/745,825

(22) Filed: May 8, 2007

(30) Foreign Application Priority Data
Jul. 6, 2006 (JP) 2006-186364

(51) Int. Cl. H04N 5/243

(52) U.S. Cl. 348/222.1; 348/E05.034

(57) ABSTRACT

An image processing system is disclosed. The image processing system includes an image characteristic information generating unit for calculating a maximal luminance value, an APL, and a luminance histogram of one frame based on an image signal to be displayed, a luminance expansion rate calculating unit for calculating a luminance expansion rate based on the maximal luminance level and the APL, a luminance expansion processing unit for performing a luminance expansion process on the image signal based on the luminance expansion ratio, a control light intensity calculating unit for calculating control light intensity based on the maximal luminance value and the APL or the luminance expansion rate, a control light intensity regulating unit for correcting the control light intensity based on the luminance histogram and generating corrected control light intensity, and a control light processing unit for generating a control signal for controlling a light controlling unit based on the corrected control light intensity, wherein the control light intensity regulating unit acquires the number of pixels having a luminance value equal to or greater than a first predetermined value based on the luminance histogram and generates the corrected control light intensity such that the luminance is decreased when a ratio of the number of the pixels to the total number of the pixels is equal to or greater than a second predetermined value.

### BACKGROUND

1. Technical Field

The present invention relates to an image processing system, a display device, a program, and an information storing medium for controlling the brightness of an image.

2. Related Art

Recently, direct-vision or projection type image display devices using liquid crystals nave penetrated into the market. As for the projection type, the projection type image display devices using DMDs (Digital Micromirror Device) along with the projection type image display devices using liquid crystals are available as products in the market. DMD is a trademark of U.S. Texas Instruments Incorporated.

There is a problem in that sufficient contrast cannot be acquired due to the leakage of light which is generated from various optical elements constructing an optical system or stray light in the image display devices. Since the luminance of the white color is always constant in the image display devices, when white color areas increase, the screen becomes too bright to watch.

In order to solve the problems, a dimmer control method combining a dimming process and a luminance expansion process based on the luminance of an input image is proposed (see JP-A-2001-343957). In the dimming control, the contrast of an image is improved by lowering the luminance of a dark image for preventing a phenomenon that a black color looks like a dark gray color and effectively using the dynamic range of a liquid crystal through the luminance expansion process.

As described above, the brightness control for a dark image was important in the past.

In addition, an ABL (Auto Brightness Limited) control method in which the luminance is automatically regulated for an image signal having a high luminance is proposed (see JP-A-2001-86429).

However, in the dimmer control, it is required to increase the luminance when an image is bright and to decrease the luminance when the image is dark. On the other hand, in the ABL control, it is required to decrease the luminance when the image is bright and to increase the luminance when the image is dark.

Since the controlling methods are conflicting with each other, the controlling methods cannot be simply combined together for being used.

### SUMMARY

An advantage of some aspects of the invention is to provide an image processing system, a display device, a program, and an information storing medium capable of increasing the contrast of an image by dimmer control and displaying an image having a proper brightness even in a case where a bright image is displayed.

According to an aspect of the invention, there is provided an image processing system comprising an image characteristic information generating unit for calculating a maximal luminance value, an APL, and a luminance histogram of one frame based on an image signal to be displayed, a luminance expansion rate calculating unit for calculating a luminance expansion rate based on the maximal luminance level and the APL, a luminance expansion processing unit for performing a luminance expansion process on the image signal based on the luminance expansion ratio, a control light intensity calculating unit for calculating control light, intensity based on the maximal luminance value and the APL or the luminance expansion rate, a control light intensity regulating unit for correcting the control light intensity based on the luminance histogram and generating corrected control light intensity, and a control light processing unit for generating a control signal for controlling a light controlling unit based on the corrected control light intensity. The control light intensity regulating unit acquires the number of pixels having a luminance value equal to or greater than a first predetermined value based on the luminance histogram and generates the corrected control light intensity such that the luminance is decreased when a ratio of the number of the pixels to the total number of the pixels is equal to or greater than a second predetermined value.

According to another aspect of the invention, there is provided a display device comprising the image processing system, the light controlling unit, and a display unit for displaying an image based on an image signal on which the luminance expansion process is performed.

According to a further aspect of the invention, there is provided a program allowing a computer to serve as an image characteristic information generating unit for calculating a maximal luminance value, an APL, and a luminance histogram of one frame based on an image signal to be displayed, a luminance expansion rate calculating unit for calculating a luminance expansion rate based on the maximal luminance level and the APL, a luminance expansion processing unit for performing a luminance expansion process on the image signal based on the luminance expansion ratio, a control light intensity calculating unit for calculating control light intensity based on the maximal luminance value and the APL or the luminance expansion rate, a control light intensity regulating unit for correcting the control light intensity based on the luminance histogram and generating corrected control light intensity, and a control light processing unit for generating a control signal for controlling a light controlling unit based on the corrected control light intensity. The control light intensity regulating unit acquires the number of pixels having a luminance value equal to or greater than a first predetermined value based on the luminance histogram and generates the corrected control light intensity such that the luminance is decreased when a ratio of the number of the pixels to the total number of the pixels is equal to or greater than a second predetermined value.

According to a still further aspect of the invention, there is provided a computer-readable information storing medium storing the program.

According to the aspect of the invention, the image processing system or the like can increase the contrast of an image by controlling control light and decrease the luminance in a case where there are many pixels having high luminance levels, thereby capable of displaying an image having an appropriate brightness even in a case where a bright image is displayed.

In addition, the control light intensity regulating unit may generate the corrected control light intensity such that the luminance is increased when the ratio is equal to or greater than a third predetermined value and is less than the second predetermined value.

In this case, the image processing system or the like can prevent darkening of the image by a control light controlling process when there are not many pixels having high luminance levels.

In addition, the image characteristic information generating unit may acquire a maximal luminance value, an APL, and a luminance histogram of a center area which is positioned a predetermined number of pixels inside from the outmost part of the image as the maximal luminance value, the APL, and the luminance histogram.

In this case, the image processing system or the like can suppress the effect of a subtitle or a black band which are included in an edge portion of an image, thereby capable of appropriately performing an image process based on the luminance distribution of the image.

In addition, the image characteristic information generating unit may divide the image into a plurality of pixel blocks and acquire the maximal luminance value, the APL, and the luminance histogram based on an average value or a representative value of pixels of each pixel block including a plurality of pixels.

In this case, the image processing system or the like can suppress the effect of a noise included in an image signal, thereby capable of performing an image process based on the luminance distribution of the image, more appropriately.

In addition, the luminance expansion rate calculating unit may calculate the luminance expansion rate based on a luminance expansion rate lookup table in which the luminance expansion rate is determined by a combination of the maximal luminance value and the APL, and the luminance expansion rate lookup table may be configured such that a high luminance expansion rate, compared with a case where the APL is greater than a middle value, is set when the APL is less than a middle value.

In this case, the image processing system or the like can perform a stronger luminance expansion process on an image which is dark on the whole.

In addition, the image processing system and the display apparatus may further comprise an expansion rate adjusting unit for adjusting the luminance expansion rate, and the expansion rate adjusting unit may determine whether a luminance expansion rate of the current frame is identical to that of a frame which is two frames before and the luminance expansion rate of the current frame is identical to that of a previous frame, when the result of the determination is true, the expansion rate adjusting unit may apply the luminance expansion rate which was applied previously, and when the result of the determination is false, the expansion rate adjusting unit may determine the luminance expansion rate based on the change in the luminance expansion rate of the two frames in the past.

In addition, the program and the information recording medium may allow a computer to serve as an expansion rate adjusting unit for adjusting the luminance expansion rate, and the expansion rate adjusting unit may determine whether a luminance expansion rate of the current frame is identical to that of a frame which is two frames before and the luminance expansion rate of the current frame is identical to that of a previous frame, when the result of the determination is true, the expansion rate adjusting unit may apply the luminance expansion rate which was applied previously, and when the result of the determination is false, the expansion rate adjusting unit may determine the luminance expansion rate based on the change in the luminance expansion rate of the two frames in the past.

In this case, the image processing system or the like can prevent the generation of image flickering by applying the same luminance expansion rate in a case where the luminance changes periodically. In addition, the image processing system or the like is capable of displaying an image based on an actual change in the image and preventing image flickering of the image in a case where the luminance abruptly changes by determining a luminance expansion rate depending on the change in the luminance expansion rate for the two frames in the past.

### BRIEF DESCRIPTION OF THE DRAWINGS

The invention will be described with reference to the accompanying drawings, wherein like numbers reference like elements.

FIG. 1 is a diagram showing functional blocks of a display device according to an embodiment of the invention.

FIG. 2 is a flowchart showing an image processing flow according to an embodiment of the invention.

FIG. 3 is a diagram showing relationship among an image, a center block, and a pixel block.

FIG. 4 is a schematic diagram of a luminance expansion rate LUT according to an embodiment of the invention.

FIG. 5 is a diagram showing a case where four points are defined as the luminance expansion rate LUT according to an embodiment of the invention.

FIG. 6 is a diagram showing a case where three points are defined as the luminance expansion rate LUT according to an embodiment of the invention.

FIG. 7 is a table showing an example of the luminance expansion rate LUT according to an embodiment of the invention.

FIG. 8 is a diagram showing a relationship between the ratio of a white pixel area and a control light correction rate according to an embodiment of the invention.

FIG. 9 is a table showing an example of control light intensity LUT according to an embodiment of the invention.

FIG. 10 is a diagram showing functional blocks of a display device according to another embodiment of the invention.

FIG. 11 is a schematic diagram showing an update amount LUT for luminance expansion according to an embodiment of the invention.

### DESCRIPTION OF EXEMPLARY EMBODIMENTS

Hereinafter, a case where the present invention is applied to a display device will be described with reference to the accompanying drawings. The invention described in the claims is not limited to the embodiments to be described below at all. In addition, all the elements shown in the embodiments described below are not required as solving means of the invention described in the claims.

### First Embodiment

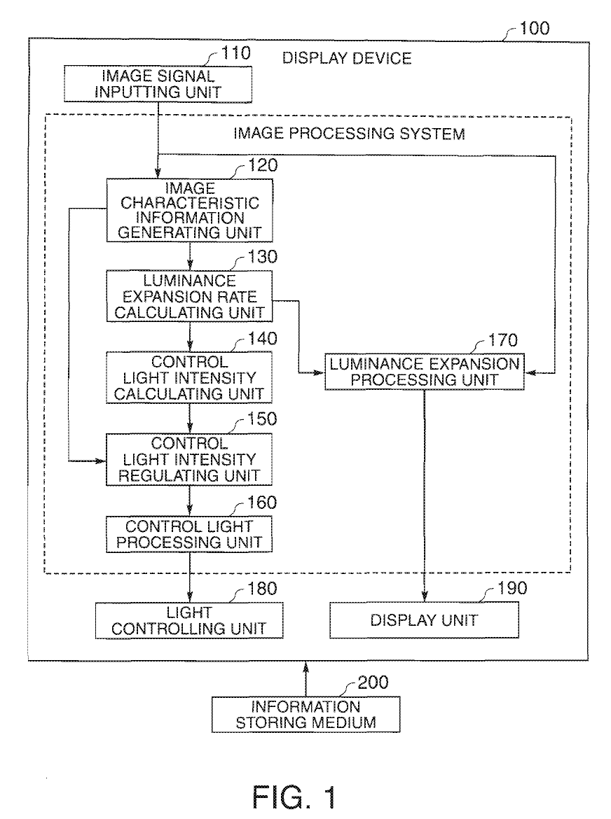

FIG. 1 is a diagram showing functional blocks of a display device 100 according to this embodiment of the invention.

The display device 100 includes an image signal input unit 110 which inputs an image signal (for example, an RGB signal), an image characteristic information generating unit 120 which acquires a maximal luminance value (white peak level, WP), an APL (Average Picture Level), and a luminance histogram in one frame based on the image signal, and a luminance expansion rate calculating unit 130 which calculates the luminance expansion rate based on the maximal luminance value and the APL.

In addition, the display device 100 includes a control light intensity calculating unit 140 which calculates the control light intensity based on the luminance expansion rate, a control light intensity regulating unit 150 which corrects the control light intensity based on a luminance histogram to generate a corrected control light intensity, a control light processing unit 160 which generates a control signal for controlling a light controlling unit 180 based on the corrected control light intensity, and a luminance expansion processing unit 170 which performs a luminance expansion process on the image signal based on the luminance expansion ratio.

In addition, the display device 100 includes the light controlling unit 180 which performs a control light controlling process based on a control signal from the control light intensity processing unit 160 and a display unit 190 which displays an image based on the image signal of which luminance is expanded.

The image characteristic information generating unit 120, the luminance expansion rate calculating unit 130, the control light intensity calculating unit 140, the control light intensity regulating unit 150, the control light intensity processing unit 160, and the luminance processing unit 170 also serve as an image processing system.

The control light intensity processing unit 160 controls the light controlling unit 180, for example, to reduce the light by about 20% from the maximal output level in an initial status.

The followings may be employed as hardware for implementing the functions of the above-described units. For example, an input port or the like as the image signal input unit 110, an image processing circuit, a CPU, a RAM, and the like as the image characteristic information generating unit 120, the luminance expansion rate calculating unit 130, the control light intensity calculating unit 140, the control light intensity regulating unit 150, the control light intensity processing unit 160, and the luminance processing unit 170, a lamp power unit (having a function of controlling the luminance of a lamp by controlling power), a light shielding plate (having a function of shielding an output light beam), a liquid crystal light valve (having a function of shielding an output light beam), and the like as the light controlling unit 180, and a liquid crystal light valve, a light source, a liquid crystal driver, and the like as the display unit 190 may be employed.

The display device 100 may load the functions of the units described above by reading and loading a program from an information storing medium 200. As the information storing medium 200, for example, a CD-ROM, a DVD-ROM, a ROM, a RAM, an HDD, or the like may be employed, and the method of reading the program may be a contacting type or a non-contacting type.

Next, the image processing flow using the above-described units will be described.

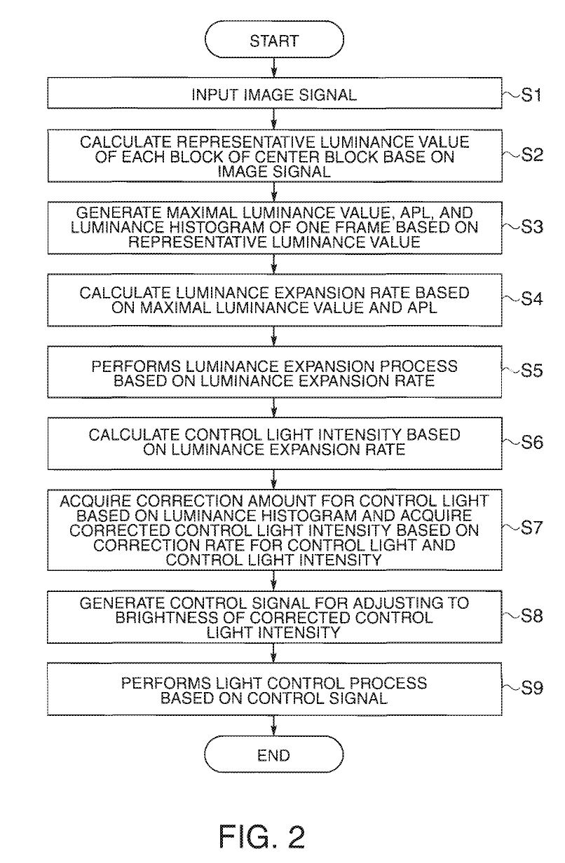

FIG. 2 is a flowchart showing an image processing flow according to an embodiment of the invention.

The image signal input unit 110 inputs an image signal from an image signal supplying apparatus (for example, a DVD player or a PC) (step S1).

The image characteristic information generating unit 120 calculates a representative luminance (average luminance value) for each pixel block in a center block of an image based on the image signal (step S2).

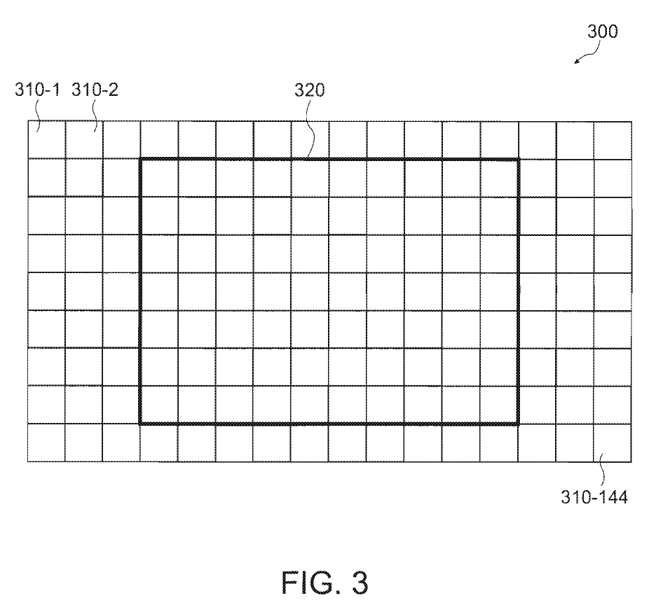

FIG. 3 is a diagram showing relationship among an image 300, a center block 320, and a pixel block 310.

For example, for an image 300 of 1280 columns of pixels and 720 rows of pixels, the image characteristic information generating unit 120 divides the image 300 into 144 pixel blocks 310-1 to 310-144 having 16 columns of pixel blocks and 9 rows of pixel blocks. The image characteristic information generating unit 120 calculates a representative luminance value based on the pixel blocks 310 of the center block 320 excluding pixel blocks 310 in the uppermost and lowermost rows or leftmost three columns and rightmost three columns.

In this case, one pixel block 310 includes 80 pixels. The image characteristic information generating unit 120 stores an average value of luminance values for the pixels constituting the pixel block 310 in a RAM or the like as a representative luminance value of the pixel block 310. For example, a maximal value of each signal of RGB signals may be used as the luminance value, or alternatively, the sum of 0.299×R signal value, 0.587×G signal value, and 0.144×B signal value may be used as the luminance value. In addition, the representative luminance value is not limited to an average luminance value, and, for example, a luminance value (representative value) of a pixel around the center of the pixel block 310 may be used as the representative luminance value.

The image characteristic information generating unit 120 sets the maximal luminance value (white peak value, WP) to a maximal value among the representative luminance values of each pixel block 310 constituting the center block 320, sets the APL to the average value of the representative luminance values, and generates a luminance histogram based on the distribution of the representative luminance level (step S3).

Alternatively, the image characteristic information generating unit 120 respectively may calculate a maximal luminance value and an APL for the center block 320 and a peripheral region other than the center block 320 and calculate a weighted average (for example, a value of the center block 320×0.9+a value of the peripheral region×0.1).

The luminance expansion rate calculating unit 130 calculates a luminance expansion rate based on the maximal luminance value and the APL with reference to the luminance expansion rate LUT (step S4).

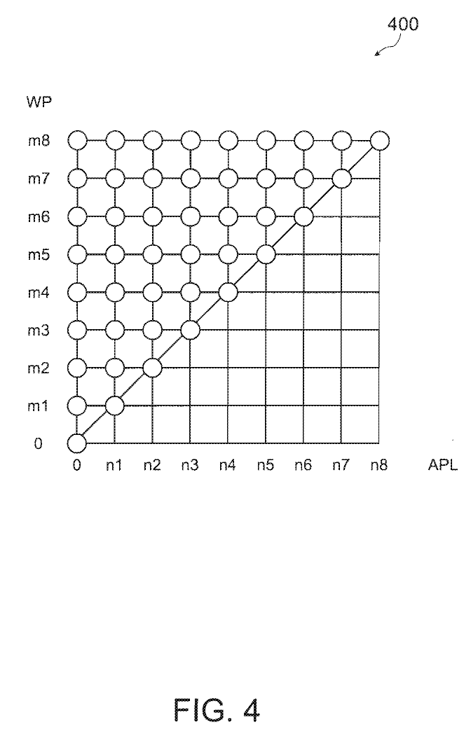

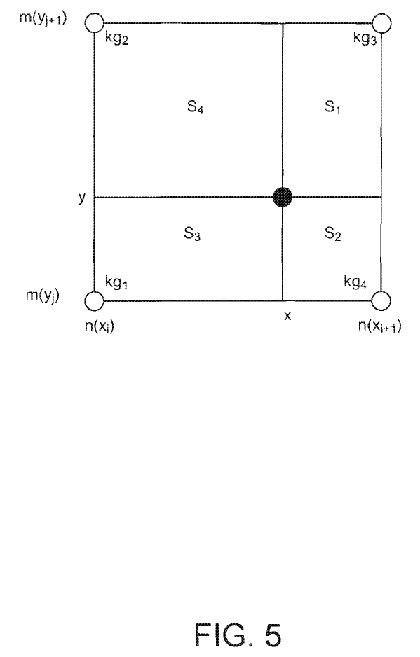

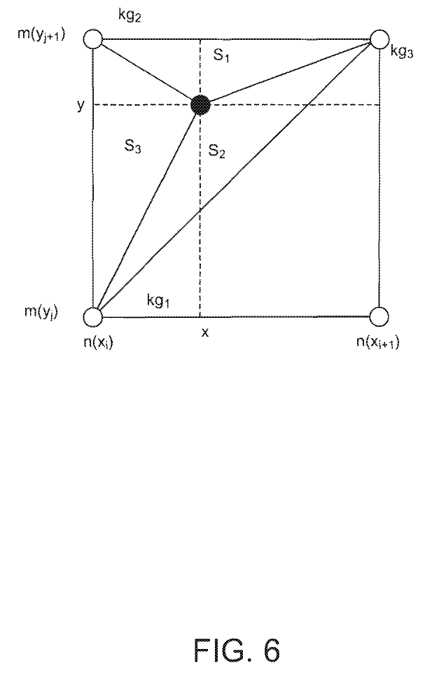

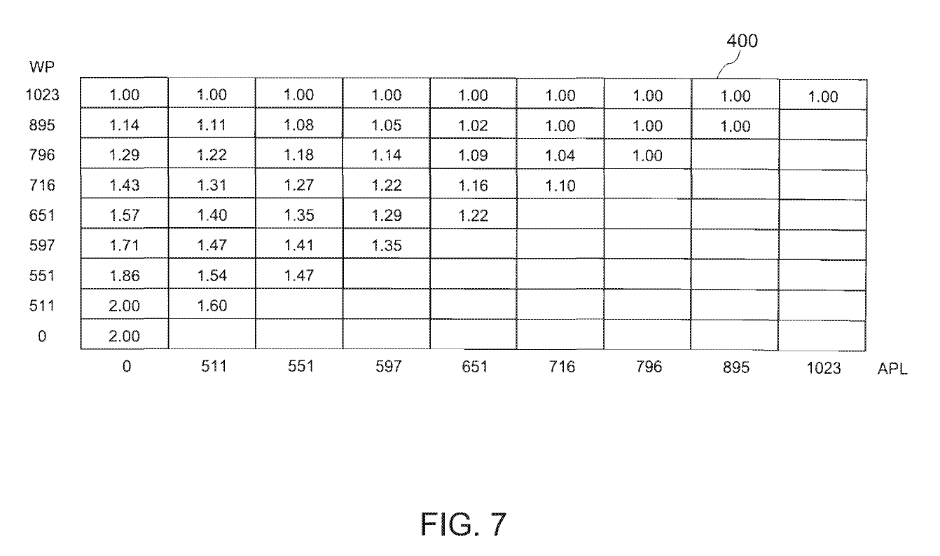

FIG. 4 is a schematic diagram of a luminance expansion rate LUT400 according to an embodiment of the invention. FIG. 5 is a diagram showing a case where four points are defined as the luminance expansion rate LUT400 according to an embodiment of the invention. FIG. 6 is a diagram showing a case where three points are defined as the luminance expansion rate LUT400 according to an embodiment of the invention. FIG. 7 is a table showing an example of the luminance expansion rate LUT400 according to an embodiment of the invention.

Since the average value (APL) does not exceed the maximal value (maximal luminance value, WP) in any case, values are not defined on the right-down side in FIGS. 4 and 7. The luminance expansion rate calculating unit 130 can decrease the memory capacity for storing the luminance expansion rate LUT400 by configuring the luminance expansion rate LUT400 as described above.

For example, when the APL is 400 and the WP is 550, as shown in FIG. 7, it corresponds to a portion during when four points are defined. In this case, the luminance expansion rate calculating unit 130, as shown in FIG. 5, acquires the luminance expansion rate kg by calculating (kg1·S1+kg2·S2+kg3·S3+kg4·S4)/(S1+S2+S3+S4).

For example, when the APL is 400 and the WP is 500, as shown in FIG. 7, it corresponds to a portion during when three points are defined. In this case, the luminance expansion rate calculating unit 130, as shown in FIG. 6, acquires the luminance expansion rate kg by calculating (kg1·S1+kg2·S2+kg3·S3)/(S1+S2+S3).

As described above, the luminance expansion rate calculating unit 130 can calculate the luminance expansion rate kg by performing interpolation even for a value which is not defined as the luminance expansion rate LUT400.

When WP has a small value, a larger value is set as the luminance expansion rate LUT400 compared with a case where WP has a large value. In addition, when the APL has a small value, a larger value is set as the luminance expansion rate LUT400 compared with a case where the APL has a large value. As described above, the luminance expansion rate LUT400 is configured such that the luminance expansion rate LUT400 decreases when the image 300 is bright.

The luminance expansion processing unit 170 expands the luminance of the image signal from the image signal input unit 110 by the luminance expansion rate acquired by the luminance expansion rate calculation unit 130 (step S5).

For example, when the color information of the image signal is R, G, and, B and the color information after the expansion in the luminance is R′, B′, G′, then, R′−kg×R, G′−kg×G, and B+=kg×B.

The luminance expansion process is performed in a sequence described above. Next, the control light processing will be described.

The control light intensity calculating unit 140 calculates a control light intensity based on the luminance expansion rate from the luminance expansion rate calculating unit 130 (step S6).

For example, the control light intensity KL=kg^{-γ}. Here, γ is a constant value, for example, 2,2. The control light intensity KL is a luminance value when the maximal luminance value of a light source is set to 1.0.

The control light intensity regulating unit 150 acquires a control light correcting rate F from the control light correction LUT based on the luminance histogram generated by the image characteristic information generating unit 120 and calculates a corrected control light intensity KL′ based on the control light correction rate F and the control light intensity KL (step S7).

To be more specifically, the control light intensity regulating unit 150 acquires a ratio R (a ratio of white screen area) of the number of pixel blocks (or the number of pixels), the luminance values of which are equal to or greater than a first predetermined value Yp (for example, a maximal value of a luminance value×0.9) from the luminance histogram.

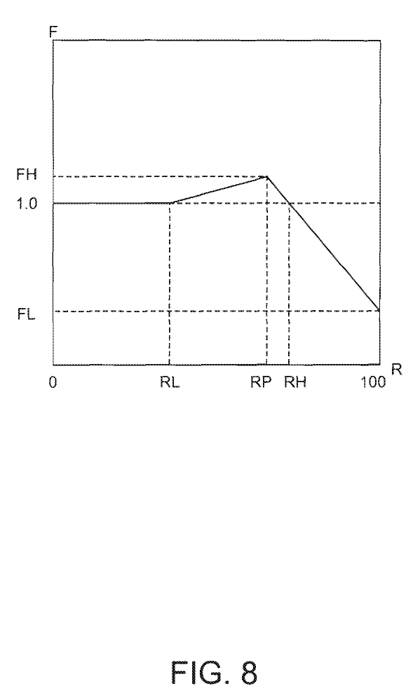

FIG. 8 is a diagram showing a relationship between the ratio of white pixel area and the control light correction rate according to an embodiment of the invention.

In FIG. 8, RL which is an inflection point is in the range of 10 to 60, RP is in the range of 50 to 70, and RH is in the range of 70 to 80, as an example. In addition, in FIG. 8, FH is 1.1 and FL is 0.5, as an example.

When R is equal to or greater than zero and less than RL (third predetermined value), F is one. When R is equal to or greater than RL (third predetermined value) and less than RH (second predetermined value), F is equal to or greater than 1 and equal to or less than FH. When R is equal to or greater than RH (second predetermined value) and equal to or less than 100, F is equal to or greater than FL and equal to or less than one.

In addition, the control light intensity regulating unit 150 acquires corrected control light intensity by using KL′=F×KL. In other words, when the ratio of the white pixel area is equal to or greater than RH, the control light intensity regulating unit 150 determines that the whole image is bright and corrects the control light intensity, so that the luminance is decreased. On the other hand, when the ratio of the white pixel area is less than RL, the control light intensity regulating unit 150 determines that the whole image is not too bright and uses the original control light intensity without correcting the luminance. In addition, when the ratio of the white pixel area is equal to or greater than RL and is less than RH, the control light intensity regulating unit 150 corrects the control light intensity to increase the luminance for a brighter image.

As described above, the control light intensity processing unit 160 controls the light controlling unit 180, so that the luminance is decreased by 20% in an initial state. Accordingly, when the image has brightness for which the expansion in the luminance has a little effect on the image quality (R is equal to or greater than RL and is less than RH), the control light intensity processing unit 160 increases the luminance to acquire an appropriate luminance of the whole image.

Then, the control light intensity processing unit 160 generates a control signal for adjusting to the brightness of the corrected control light intensity KL′ (step S3).

The light controlling unit 180 performs a light control process (for example, luminance adjustment by power control) based on the control signal (step S9).

The display device 100 can perform the luminance expansion process of Step S5 and the light control process of Steps S6 to S9 simultaneously, and FIG. 2 doest not represent that the light control process should be performed after the luminance expansion process.

As described above, since the display device 100 according to an embodiment of the invention can increase the contrast of an image by controlling control light and decrease the luminance in a case where there are many pixels having high luminance levels, thereby capable of displaying an image having an appropriate brightness even in a case where a bright image is displayed.

In addition, according to an embodiment of the invention, the display device 100 can acquire an appropriate luminance of the whole image by increasing the luminance of the image when R is equal to or greater than RL and is less than RH, and accordingly, the darkening of the image by a control light controlling process can be prevented when there are not many pixels having high luminance levels.

In addition, according to an embodiment of the invention, the display device 100 can suppress the effect of a subtitle or a black band which are included in an edge portion of an image by performing an image process on the pixel blocks 310 within the center block 320, thereby capable of appropriately performing an image process based on the luminance distribution of the image.

In addition, according to an embodiment of the invention, the display device 100 can suppress the effect of a noise included in an image signal by using an average value of luminance values of the pixels constituting the pixel block 310 which includes a plurality of pixels, thereby capable of performing an image process based on the luminance distribution of the image, more appropriately.

In addition, according to an embodiment of the invention, when the APL is less than an middle value, the display device 100 uses a luminance expansion rate LUT in which a high luminance expansion rate, compared with as case where the APL is greater than the middle value, is set, thereby capable of performing a more strong luminance expansion process on an image which is dark on the whole.

### Second Embodiment

In the second embodiment, the control light intensity calculating unit 140 is configured to acquire the control light intensity from the control light intensity LUT based on the maximal luminance value WP and the APL.

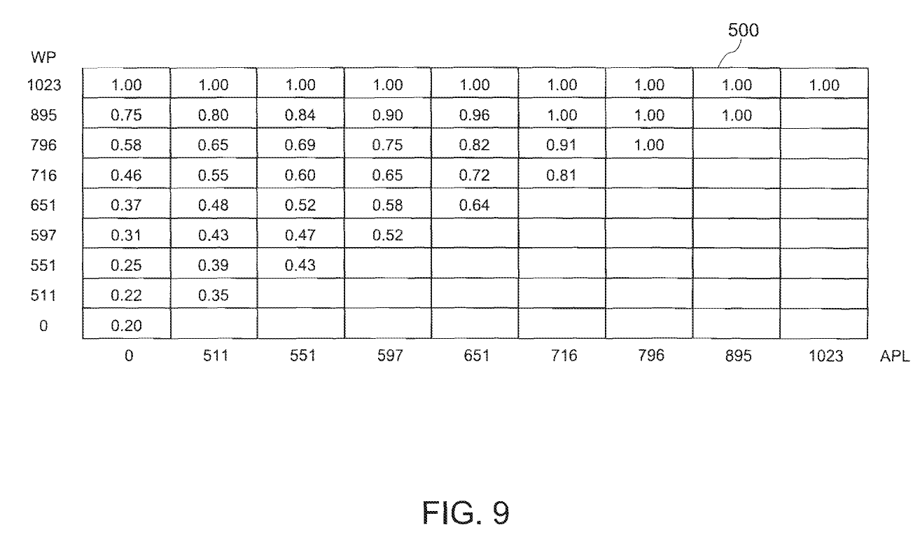

FIG. 9 is a table showing an example of control light intensity LUT500 according to this embodiment of the invention.

According to control light intensity LUT500, when WP is small, a small value, compared with a case where WP is large, is set, and when the APL is small, a small value, compares with a case where the APL is large, is set. As described above, the control light intensity LUT500 is configured to increase the control light intensity when the image 300 is bright.

The operation of the second embodiment is the same as that of the first embodiment except that the control light intensity 140 acquires control light intensity from the control light intensity LUT based on the maximal luminance value WP and the APL and that the luminance expansion rate calculating unit 130 doest not output the luminance expansion rate to the control light intensity 140.

In the second embodiment of the invention, the same effects as in the first embodiment are acquired.

### Third Embodiment

While the control light intensity regulating unit 150 acquires the corrected control light intensity using the equation “corrected control light intensity KL′=F×KL” in the first and second embodiments, the control light intensity regulating unit 150 in the third embodiment acquires the corrected control light intensity using the equation “corrected control light intensity KL′=KL+CL”.

As described above, the control light intensity regulating unit 150 can use not only a correction rate F of the corrected control light intensity KL′ but also an absolute amount CL of the corrected control light intensity. In this case, the control light intensity regulating unit 150 may perform an adjustment process, so that the calculated result is in the range of 0 to 1.

### Fourth Embodiment

The display device 100 may perform the image process on each pixel instead of using the pixel block 310. In other words, the image characteristic information generating unit 120 may acquire the WP, the APL and the luminance histogram directly from a luminance value of each pixel.

### Fifth Embodiment

In the fifth embodiment, the display device 100 includes an expansion rate adjusting unit. The expansion rate adjusting unit determines whether a luminance expansion rate of the current frame is identical to a luminance expansion rate of a frame which is two frames before and the luminance expansion rate of the current frame is identical to a luminance expansion rate of a previous frame. When the result of the determination is true, the expansion rate adjusting unit applies the luminance expansion rate which was applied previously. On the other hand, when the result of the determination is false, the expansion rate adjusting unit determines the luminance expansion rate based on the change in the luminance expansion rate of two frames in the past.

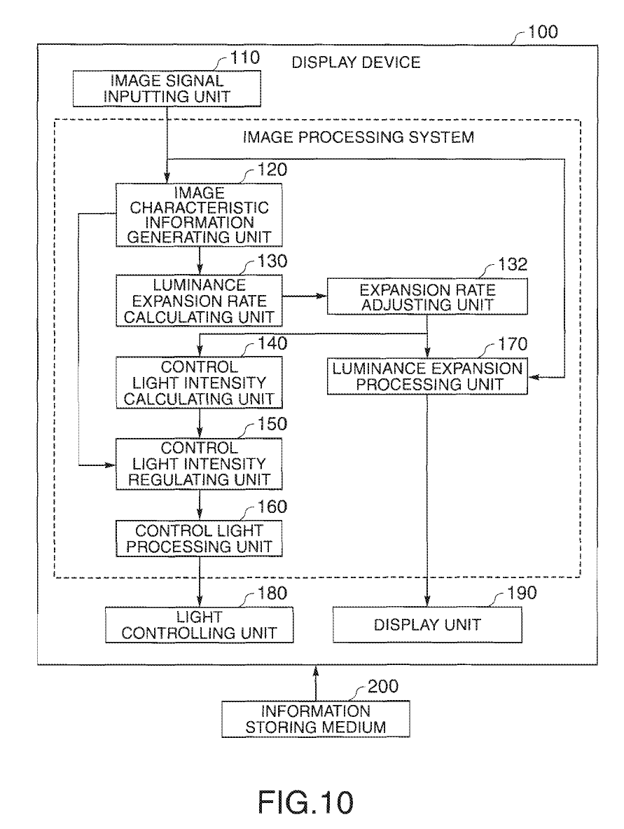

FIG. 10 is a diagram showing functional blocks of a display device according to this embodiment of the invention.

The luminance expansion rate calculating unit 130 is configured to output information indicating the luminance expansion rate to an expansion rate adjusting unit 132, and the control light intensity calculating unit 140 and the luminance processing unit 170 are configured to receive the information indicating the luminance expansion rate after adjustment from the expansion rate adjusting unit 132 as input.

Here, the luminance expansion rate of the current frame is denoted as kgₒ, the luminance expansion rate of the previous frame is denoted as kg₋₁, the luminance expansion rate of a frame which is positioned two frames before is denoted as k_{g-2}, the luminance expansion rate of the current frame after adjustment is denoted as kfgₒ, and the luminance expansion rate of the previous frame after adjustment is denoted as kfg₋₁.

The expansion rate adjusting unit 132 at first determines whether the luminance expansion rate from the luminance expansion rate calculating unit 130 vibrates. This operation is performed since when the luminance expansion process is performed with the luminance expansion rate vibrating, the luminance changes periodically, and accordingly, the flickering is recognized or the light controlling unit 180 is driven more than necessary. Thus, in this case, there is a possibility that a noise from the light controlling unit 180 or the shortening the lifetime of the light controlling unit 180 occurs.

The expansion rate adjusting unit 132 determines whether kgₒ is identical to kg₋₂ and kgₒ is not identical to kg₋₁. When the result of the determination is true, the expansion rate adjusting unit 132 applies the previously applied luminance expansion rate kfg₋₁ as the luminance expansion rate after adjustment kfgₒ.

On the other hand, when the result of the determination is false, the expansion rate adjusting unit 132 determines the luminance expansion rate based on the change in the luminance expansion rate of the two frames in the past.

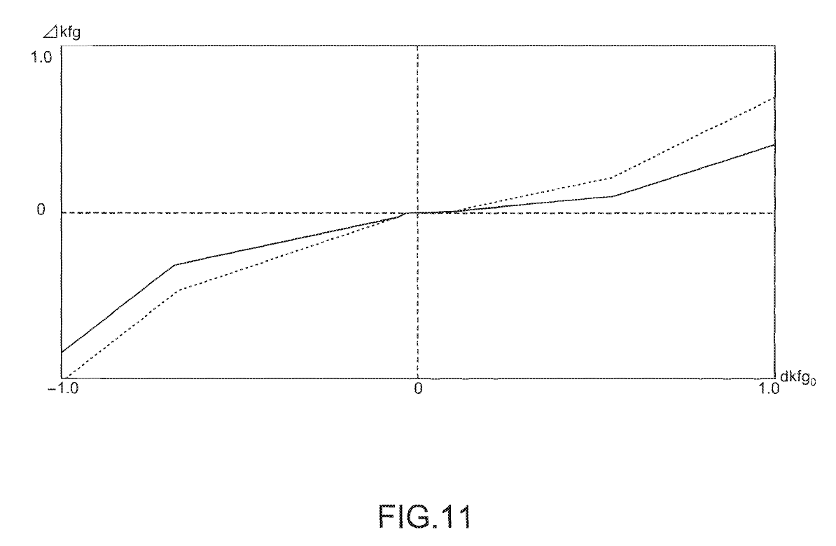

FIG. 11 is a schematic diagram, showing an update amount LUT for luminance expansion according to this embodiment of the invention.

To be more specifically, the expansion rate adjusting unit 132 calculates dkgₒ and dkg₋₁ by using the equations dkgₒ=kgₒ−kg₋₁ and dkg₋₁−kg₋₂. Then, the expansion rate adjusting unit. 132 determines (second determination) whether the condition that the signs of dkgₒ and dkg₋₁ are different with each other or one of dkgₒ and dkg₋₁ is zero is established. When the result of the second determination is true, the expansion rate adjusting unit 132 acquires the update amount Δkfg based on the LUT which is shown as a solid line in FIG. 11.

On the other hand, when the result of the second determination is false, the expansion rate adjusting unit 132 determines whether the signs of dkgₒ and dkg₋₁ are positive and dkg₋₁ is equal to or greater than a threshold value (for example, 0.2). When the result of the determination is true, the expansion rate adjusting unit 132 acquires the update amount Δkfg based on the LUT which is shown as a dotted line in FIG. 11. When the signs of dkgₒ and dkg₋₁ are positive and dkg₋₁ is less than a threshold value (for example 0.2), the expansion rate adjusting unit 132 acquires the update amount Δkfg based on the LUT which is shown as a solid line in FIG. 11.

When the result of the second determination is false, the expansion rate adjusting unit 132 determines whether the signs of dkgₒ and dkg₋₁ are negative and dkg₋₁ is equal to or less than a threshold value (for example, −0.2). When the result of the determination is true, the expansion rate adjusting unit 132 acquires the update amount Δkfg based on the LUT which is shown as a dotted line in FIG. 11. When the signs of dkgₒ and dkg₋₁ are negative and dkg₋₁ is greater than a threshold value (for example −0.2), the expansion rate adjusting unit 132 acquires the update amount Δkfg based on the LUT which is shown as a solid line in FIG. 11.

As described above, when the luminance values for the two frames in the past change in a same direction and the change is large, the expansion rate adjusting unit 132 uses LUT shown as a dotted line which changes the expansion rate much, and when the change is small or the luminance values for the two frames in the past change in a different direction, the expansion rate adjusting unit 132 uses LUT shown as a solid line which changes the expansion rate less.

The difference between the luminance expansion rate of the current frame and the luminance expansion rate of the previous frame after adjustment dkfgₒ=kgₒ−kfg₋₁. The luminance expansion rate of the current frame after adjustment dkfgₒ=kfg₋₁−Δkfg.

The expansion rate adjusting unit 132 outputs the luminance expansion rate kfgₒ to the control light intensity calculating unit 140 and the luminance expansion processing unit 170.

As described above, the display device 100 according to the embodiment of the invention can prevent flickering of an image by applying the same luminance expansion rate in a case where a periodical change in luminance occurs. In addition, the display device 100 according to the embodiment of the invention can display an image based on an actual change in the image and prevent image flickering of the image in a case where the luminance abruptly changes by determining a luminance expansion rate depending on the change in the luminance expansion rate for the two frames in the past.

### Other Embodiments

The invention is not limited to the embodiments described above and various changes may be made.

For example, the display device 100 is not limited to a display device using a liquid crystal, and may be, for example, a display device using a DMD or the like. Alternatively, the display device 100 may be a projection TV, a projector, a display, or the like.

Moreover, the function of the display device 100 may be divided into a plurality of devices. For example, the invention can be applied to a case where an image is displayed using a PC having an image processing system shown in FIG. 1 and a projector.

Although the display device 100 acquires the changes in two frames in the past in the fifth embodiment of the invention, the luminance expansion process may be performed by acquiring the changes, for example, in three or more frames in the past.

The entire disclosure of Japanese Patent Application No. 2006-186364, filed Jul. 6, 2006 is expressly incorporated by reference herein.

What is claimed is:

1. An image processing system comprising:
an image characteristic information generating unit for calculating a maximal luminance value, an APL, and a luminance histogram of one frame based on an image signal to be displayed;
a luminance expansion rate calculating unit for calculating a luminance expansion rate based on the maximal luminance level and the APL;
a luminance expansion processing unit for performing a luminance expansion process on the image signal based on the luminance expansion ratio;
a control light intensity calculating unit for calculating control light intensity based on the maximal luminance value and the APL or the luminance expansion rate;
a control light intensity regulating unit for correcting the control light intensity based on the luminance histogram and generating corrected control light intensity; and
a control light processing unit for generating a control signal for controlling a light controlling unit based on the corrected control light intensity,
wherein the control light intensity regulating unit acquires the number of pixels having a luminance value equal to or greater than a first predetermined value based on the luminance histogram and generates the corrected control light intensity such that the luminance is decreased when a ratio of the number of the pixels to the total number of the pixels is equal to or greater than a second predetermined value.

2. The image processing system according to claim 1,
wherein the control light intensity regulating unit generates the corrected control light intensity such that the luminance is increased when the ratio is equal to or greater than a third predetermined value and is less than the second predetermined value.

3. The image processing system according to claim 1,
wherein the image characteristic information generating unit acquires a maximal luminance value, the APL, and a luminance histogram of a center area which is positioned a predetermined number of pixels inside from the outmost part of the image as the maximal luminance value, the APL, and the luminance histogram.

4. The image processing system according to claim 1,
wherein the image characteristic information generating unit divides the image into a plurality of pixel blocks and acquires the maximal luminance value, the APL, and the luminance histogram based on an average value or a representative value of pixels of each pixel block including a plurality of pixels.

5. The image processing system according to claim 1,
wherein the luminance expansion rate calculating unit calculates the luminance expansion rate based on a luminance expansion rate lookup table in which the luminance expansion rate is determined by a combination of the maximal luminance value and the APL, and
wherein the luminance expansion rate lookup table is configured such that a high luminance expansion rate, compared with a case where the APL is greater than a middle value, is set when the APL is less than a middle value.

6. The image processing system according to claim 1,
further comprising an expansion rate adjusting unit for adjusting the luminance expansion rate,
wherein the expansion rate adjusting unit determines whether a luminance expansion rate of the current frame is identical to that of a frame which is two frames before and the luminance expansion rate of the current frame is identical to that of a previous frame, when the result of the determination is true, the expansion rate adjusting unit applies the luminance expansion rate which was applied previously, and when the result of the determination is false, the expansion rate adjusting unit determines the luminance expansion rate based on the change in the luminance expansion rate of the two frames in the past.

7. A display device comprising:
the image processing system according to claim 1;
the light controlling unit; and
a display unit for displaying an image based on an image signal on which the luminance expansion process is performed.

8. A program allowing a computer to serve as:
an image characteristic information generating unit for calculating a maximal luminance value, an APL, and a luminance histogram in one frame based on an image signal to be displayed;
a luminance expansion rate calculating unit for calculating a luminance expansion rate based on the maximal luminance level and the APL;
a luminance expansion processing unit for performing a luminance expansion process on the image signal based on the luminance expansion ratio;
a control light intensity calculating unit for calculating control light intensity based on the maximal luminance value and the APL or the luminance expansion rate;
a control light intensity regulating unit for correcting the control light intensity based on the luminance histogram and generating corrected control light intensity; and
a control light processing unit for generating a control signal for controlling a light controlling unit based on the corrected control light intensity,
wherein the control light intensity regulating unit acquires the number of pixels having a luminance value equal to or greater than a first predetermined value based on the luminance histogram and generates corrected control light intensity such that the luminance is decreased when a ratio of the number of pixels to the total number of the pixels is equal to or greater than a second predetermined value.

9. A computer-readable information storing medium storing the program according to claim 8.
